(19) United States
(12) Patent Application Publication
(10) Pub. No.: US 2007/0258824 A1
(43) Pub. Date: Nov. 8, 2007

(54) ROTOR FOR VISCOUS OR ABRASIVE FLUIDS

(75) Inventors: JOHN PACELLO, Chestermere (CA); PETER T. MARKOVITCH, Calgary (CA)

Correspondence Address: BENNETT JONES;C/O MS ROSEANN CALDWELL, 4500 BANKERS HALL EAST, 855 - 2ND STREET, SW, CALGARY, AB, T2P 4K7, CA

(73) Assignee: 1134934 ALBERTA LTD., Calgary (CA)

(21) Appl. No.: 11/307,342

(22) Filed: Feb. 1, 2006

Related U.S. Application Data
(60) Provisional application No. 60/648,392, filed on Feb. 1, 2005.

(51) Int. Cl. F03B 3/14

(52) U.S. Cl. 416/223 R; 366/315; 417/423.1

(57) ABSTRACT

A rotor is disclosed comprising a drive disk and a plurality of driven disks in a stack, the stacked disks in spaced relationship along the rotational axis thereby forming inter-disk spaces. A centrally positioned aperture is provided in each of the driven disks, opening into the inter-disk spaces. A hub is connected to the drive disk for communication with a drive shaft, and there is a plurality of axial vanes within the apertures and attached to the disks, wherein rotation of the rotor causes fluids to be drawn into the apertures and then into the inter-disk spaces. The rotor can be employed with centrifugal pumps and mixers.

### FIELD OF THE INVENTION

The present invention relates to rotors and impellers, and more particularly to rotors and impellers that can be used with pumps and mixers employed with viscous or abrasive fluids.

### BACKGROUND OF THE INVENTION

Centrifugal pumps have been known for a number of years. A centrifugal pump is a device that converts driver energy to kinetic energy in a liquid by accelerating it to the outer rim of a revolving device known as an impeller, or rotor. The impeller typically includes two “shrouds” facing each other, and also radial “vanes” extending from the centers of the shrouds out toward their outer peripheries and joining the shrouds together, thereby defining fluid flow channels between the shrouds. Radial vanes are typically thin, rigid, and flat, with curved surfaces sometimes present, are similar to a blade in a turbine and are used to turn the fluid. The amount of energy given to the liquid corresponds to the velocity at the edge or vane tip of the impeller. The faster the impeller revolves or the bigger the impeller, the higher the velocity of the liquid at the vane tip and the greater the energy imparted to the liquid. An example of a conventional vaned pump can be seen in U.S. Pat. No. 6,953,321 to Roudnev, et al.

As the impeller revolves, it imparts an external force on the fluid. The external force circulates the fluid around a given point to create “vortex circulation”. As the external force circulates the fluid, it accelerates the fluid in a tangential direction as the fluid moves outward. Circulating the fluid thus maintains the angular velocity of the fluid. The external force accelerates the fluid by transferring momentum from the impeller to the fluid.

The vortex circulation also creates a radial pressure gradient in the fluid. The gradient is such that the pressure increases with increasing radial distance from the centre of rotation. The rate of the pressure increase depends upon the fluid rotation speed and the density of the fluid being pumped.

There are a number of shortcomings associated with standard centrifugal pumps using a traditional impeller in viscous and abrasive liquids. These deficiencies seriously limit the application range for centrifugal pumps. Many of the problems occur in the impeller “eye” or inlet, where the fluid is first introduced into the impeller. The impact is that a conventional impeller pump can have cavitation problems, a low efficiency when pumping viscous fluids, and a low resistance to wear when pumping abrasive fluids. Although some of these shortcomings can be overcome by modifications to the pumping system, such modifications are usually expensive and can limit the performance of the pump.

When impeller vanes of a centrifugal pump travel through a fluid, they produce a pressure distribution that has a positive pressure on the forward, impinging face of the vane and a negative pressure on the rearward face of the vane. The intensity of the negative pressure zone depends on the radial flow velocity of the fluid behind the vanes and the rotational velocity of the impeller. This type of pressure distribution is inherent in a pump utilizing a vaned impeller.

Cavitation can occur in the negative pressure zone in the area having the lowest static pressure. In a standard vaned impeller, the lowest pressure is at the fluid inlet, and more specifically on the rear side of the vane at the fluid inlet. If the static pressure on the fluid in the pump drops below the vapour pressure for the fluid, vapour pockets will be formed. Cavitation occurs when the vapour pockets move from the low-pressure zone to the high-pressure area and implode. Cavitation may occur at the fluid inlet to the pump, such that cavitation difficulties will impair the operational efficiency of the entire conventional impeller pump.

In order to avoid cavitation, suction pressure must be increased so that even the low-pressure areas at the impeller inlet have sufficient pressure. Increasing suction pressure causes the static pressure to be higher than the vapour pressure of the fluid. It is very expensive, however, to provide additional inlet pressure to a pump to suppress cavitation. Also, the environment in which the pump is being used may not allow for the alterations required to increase the inlet pressure.

Simply stated, with traditional impeller designs, viscous liquids like heavy oil, highly concentrated slurries, and sludges are not able to accelerate quickly enough to fill the voids created behind the vanes of a rotating impeller. This causes the pump to cavitate and, in some instances, cease pumping altogether.

Traditional centrifugal pumps also experience shortcomings with respect to abrasion. When pumping abrasive slurries, the rate of wear is a function of the type and concentration of solids in the slurry and the velocity between the surface of the impeller and the adjacent fluid layer. There is a layer of relatively quiescent fluid, called the boundary layer, next to the surfaces of the impeller; the Reynolds number of the fluid determines the thickness of the boundary layer. The boundary layer effectively provides a protective layer of fluid that helps prevent the abrasive slurry particles from coming in contact with the surface of the impeller. However, the shielding by the boundary layer is somewhat reduced when the thickness of the boundary layer is decreased. In a pump utilizing a conventional impeller, the fluid being pumped undergoes an abrupt acceleration and change of direction as the fluid enters the rotor. Changes in acceleration and direction of flow of a fluid act to reduce the thickness of the boundary layer. As the boundary layer is reduced in thickness the particles of the fluid pass across the rotor surface at approximately the velocity at which the fluid is traveling. This produces a strong abrading action on the surface of the rotor, and the effects of the abrasive slurries are greatest at the impeller “eye” where the fluid undergoes abrupt acceleration and changes of direction. Thus, when pumping abrasive fluids, the inlet region of the impeller will receive the most harm and be the first area of the impeller to fail.

Some traditional centrifugal pumps also experience shortcomings because they do not incorporate close tolerance wear rings. Under high differential suction conditions, this allows recirculation from the exit port of the impeller, down the outside of the impeller shrouds, and back to the inlet area. This design oversight makes it impossible to perform a valid NPSH_{R} (Net Positive Suction Head Required) test that is required by many users.

Viscous fluids also adversely affect the performance of a pump using a conventional impeller. The difficulty occurs because there is a non-uniform pressure distribution on the vanes of the rotor. The non-uniform pressure distribution occurs at the inlet region of the pump where the viscous fluid is first engaged by the vanes of the rotor. The fluid flow interacting with the vanes of the rotor generate spinning eddies or Karman vortices along the rearward face of the vanes. The vortices represent lost momentum that could have been used to pump the fluid. The loss of momentum occurs in this type of pump regardless of the viscosity of the fluid, but the effects of this loss of momentum are more severe with viscous fluids. Thus, a pump utilizing a conventional impeller has reduced efficiency when pumping viscous fluids.

### SUMMARY OF THE INVENTION

An object of the invention is to provide a rotor or impeller capable of being used in contexts where viscous or abrasive materials are being addressed, such as in some pumping or mixing contexts.

An additional object of the invention is to provide an improved multiple disk centrifugal pump. A further object is to provide an improved mixer employing a rotor or impeller.

Other objects and advantages of the invention will become apparent as the invention is described hereinafter in more detail with reference to the accompanying drawings.

According to one aspect of the present invention, there is provided a rotor having a rotational axis, the rotor comprising: at least two discoid members, at least of which is a drive discoid member and at least another of which is a driven discoid member, the at least one drive discoid member and the at least one driven discoid member in spaced relationship along the rotational axis thereby forming inter-discoid spaces; a drive shaft operably coupled to the drive discoid member; a centrally positioned aperture in the at least one driven discoid member, the centrally positioned aperture by a peripheral surface and opening into the inter-discoid spaces; and, at least one axial vane operably connecting the drive discoid member and the peripheral surface of the centrally positioned aperture in the at least one driven discoid member. In operation, rotation of the rotor causes fluids to be drawn into the centrally positioned aperture in the at least one driven discoid member and then into the inter-discoid spaces.

According to another aspect of the present invention, there is provided a pump comprising a housing, an inlet, at least one outlet, a drive shaft rotatably mounted in the housing, and at least one rotor having a rotational axis and being operably coupled to the drive shaft. The at least one rotor is disposed inside and in spaced relation with the housing and has at least two discoid members, at least one of is a drive discoid member and at least another of which is a driven discoid member, the at least one drive discoid member and the at least one driven discoid member in spaced relationship along the rotational axis thereby forming inter-discoid spaces in fluid communication with the at least one outlet; a centrally positioned aperture in the at least one driven discoid member, the centrally positioned aperture being in fluid communication with the inlet and defined by a peripheral surface and opening into the inter-discoid spaces; and at least one axial vane operably connecting the drive discoid member and the peripheral surface of the centrally positioned aperture in the at least one driven discoid member. In operation, the rotation of the rotor causes fluids to be drawn into the housing through the inlet into the centrally positioned aperture in the at least one driven discoid member, then into the inter-discoid spaces and out through the outlet.

According to yet another aspect of the present invention, there is provided a mixer comprising a body and at least one rotor having a rotational axis. The at least one rotor has at least two discoid members, at least one of which is a drive discoid member and at least another of which is a driven discoid member, the at least one drive discoid member and the at least one driven discoid member being in spaced relationship to another along the rotational axis thereby forming inter-discoid spaces; a centrally positioned aperture in the at least one driven discoid member, the centrally positioned aperture defined by a peripheral surface and opening into the inter-discoid spaces; a drive shaft rotatably mounted in the body and operably coupled to the drive discoid member; and at least one axial vane attached to the drive discoid member and the peripheral surface of the centrally positioned aperture in the at least one driven discoid member. In operation, the rotation of the rotor causes fluids to be drawn into the centrally positioned aperture in the at least one driven discoid member and then into the inter-discoid spaces.

In some embodiments of the present invention, the drive discoid member and a hub form a rounded deflection surface projecting upstream toward the centrally positioned aperture, for deflecting fluids toward the inter-discoid spaces, and the at least one axial vane is positioned at an angle to the rotational axis. In some of these embodiments, the rounded deflection surface is substantially convex, and in other embodiments other curvatures are employed to deflect fluids into these spaces. Some embodiments further comprise opposed radial ribs on opposed surfaces of the at least one drive discoid member and the at least one driven discoid member.

Boundary layer viscous drag is understood with reference to friction, and it is commonly known that liquids with higher viscosity create higher friction when compared to water. Unlike typical rotors employed with centrifugal pumps where the pump must be oversized and efficiency corrected down for viscous liquids, performance may increase with viscosity when employing a rotor in accordance with the present invention.

It is normally accepted that disk impellers have relatively low NPSH characteristics. An impeller or rotor according to the present invention incorporates an integral axial flow inducer which improves the low NPSH capabilities even further.

A detailed description of exemplary embodiments of the present invention is given in the following. It is to be understood, however, that the invention is not to be construed as limited to these embodiments, which illustrate particular applications of the rotor of the present invention.

### BRIEF DESCRIPTION OF THE DRAWINGS

In the accompanying drawings, which illustrate exemplary embodiments of the present invention:

FIG. 1 is a cross-sectional view of a rotor according to the present invention in an end suction pump case;

FIG. 2 is an enlarged cross-sectional view of the rotor illustrated in FIG. 1;

FIG. 3 is a cross-sectional view of a so-called “high pressure” version of a rotor according to the present invention, illustrating the position of radial ribs;

FIG. 4 is a cross-sectional view taken along line A-A of FIG. 3;

FIG. 5 is a cross-sectional view of a multistage pump incorporating a rotor according to the present invention;

FIG. 6 is a cross-sectional view of a rotor according to the present invention for use with a mixer;

FIG. 6a is a cross-sectional view taken along line A-A of FIG. 6; and

FIG. 7 is a diagrammatic side elevation view of a mixer incorporating rotors according to the present invention.

### DETAILED DESCRIPTION OF THE INVENTION

Referring now in detail to the accompanying drawings, there are illustrated exemplary embodiments of rotors according to the present invention, as part of both a centrifugal pump and a mixer. The rotor is designed specifically for pumping heavy oil and any other viscous fluids or abrasive slurries, although it may be useful with other fluids. With the rotor, the liquid enters the suction eye in a smooth laminar flow. At least one axial flow vane at the eye of the rotor induces a positive pressure in the impeller during operation, supercharging the rotor with higher pressure reducing NPSH_{R}. As the fluid passes through the eye, that is, the axial flow space, the axial flow vane(s) provide a pressure boost to it, and then as the fluid passes into the radial flow space (between the shrouds), the shrouds increase the pressure on the fluid. In one of the embodiments, the rotor is designed for use in a multi-stage centrifugal pump, with the drive shaft extending completely through the rotor for powering engagement with additional rotors.

While elements in the different embodiments of the invention illustrated may be assigned common reference numerals from drawing to drawing, it is to be understood that elements sharing common reference numerals, while being similar in nature, are not necessarily identical and instead may have structural and other differences.

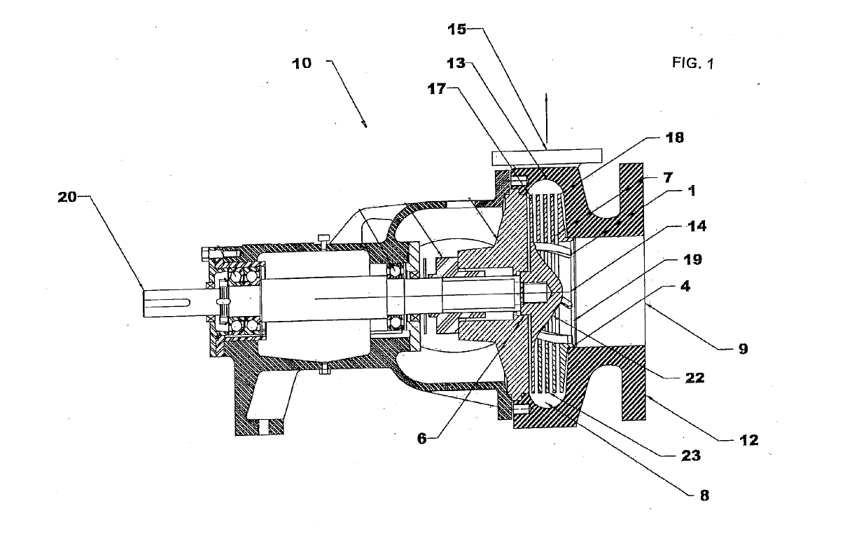

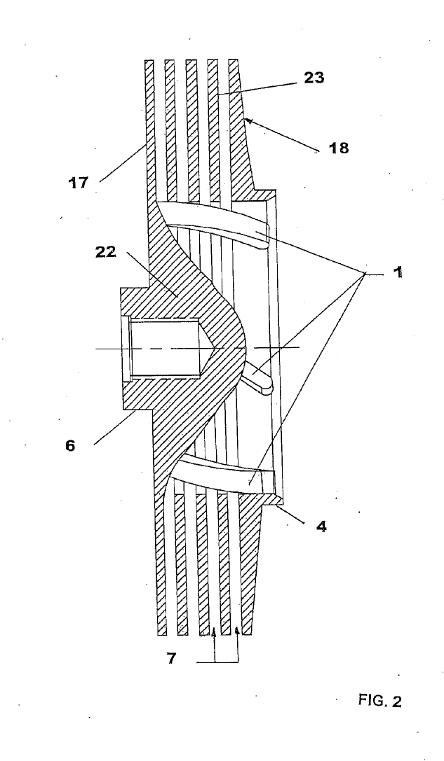

Referring now to FIGS. 1 and 2, there is illustrated a single-stage pump 10 comprising an embodiment of a rotor 14. The pump 10 pumps heavy oil and other highly viscous and abrasive slurries or sludges having high solid contents. The rotor 14 comprises a plurality of disks 17, 18, 23 disposed co-axially. The driven rotor disk (or “shroud”) 18 at the inlet end of the chamber 13 has a central inlet opening (or “eye”, or aperture) 19. The inlet opening 19 aligns with the case inlet 9 for allowing fluid (not shown) to flow from the inlet 19 into the spacing 7 between the shrouds 17, 18, 23 (disk 23 also being provided with an aperture 19). (It is to be understood that perfect alignment of the case inlet and inlet opening is not necessary as long as the two are in fluid communication; for example, without limitation, in some embodiments they may share an axis, though not necessarily a central axis.) The driven shroud 18 connects to the drive shroud 17 via the axial flow vanes 1 spaced around the periphery of the eye 19 of the driven shroud 18. The drive shroud 17 connects at its outer face 6 to a suitable drive shaft 20, which drive shaft 20 connects to a motor (not shown) for driving the rotor 14. The portion of the rotor hub 22 (which may or may not be a component separate from the drive shroud) that protrudes into the inlet 19 gently turns the liquid from axial flow to radial flow or a mixed flow pattern as it enters the spaces between the shrouds (or inter-discoid spaces).

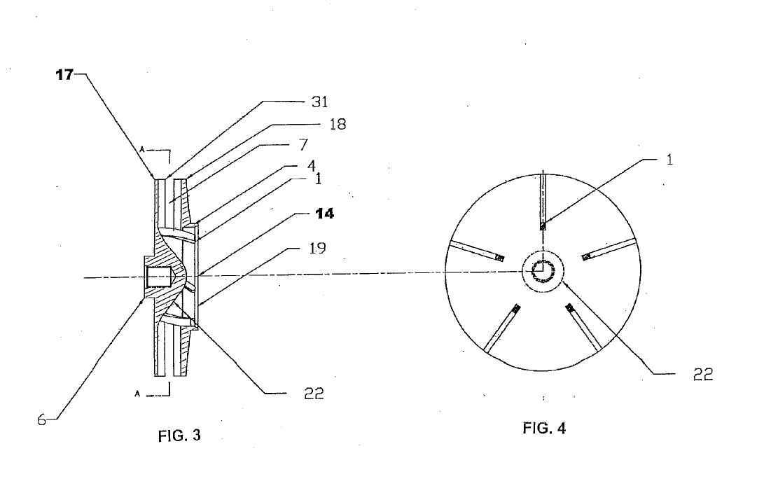

A plurality of axial flow vanes 1 are positioned across and between the plurality of adjacent circular rotor shrouds 17, 18, 23. As can best be seen in the embodiment shown in FIG. 2, the axial flow vanes 1 extend from the drive shroud 17 to the driven shroud 18, connecting all the disks (including intermediate shroud 23) in the eye area 19 at the absolute slowest velocity available in the pump 10. By their position on the outer circumference of and protrusion into the eye area 19, the axial flow vanes 1 direct the pumpage and into the radial flow portion of the rotor. The axial flow vanes 1 are shown in the embodiment of FIG. 3 as extending depthwise approximately 20% of the distance from the outer edge of the eye 19 towards the rotational centre of the rotor 14; however, it should be appreciated that axial flow vanes of different length and shape may be utilized on the rotor 14. In addition, in the embodiments shown in FIGS. 2 and 3, the axial flow vanes 1 have a “spiral” conformation; the pitch and depth of the axial flow vanes in these embodiments are selected to exceed the flow of the rotor and maintain a positive pressure on the pumpage as its flow pattern changes to radial or mixed flow. However, such axial flow vane conformation is not critical to the invention, and in other embodiments the axial flow vanes can also vary in shape and angular position.

Preferably, the disks 17, 18, 23, rotor hub 22, and axial flow vanes 1 are a cast component of a suitable alloy compatible with the pumpage (the fluid being pumped). Accordingly, cast axial flow vanes preferably secure all of these components into a single unit. The cast vanes 1 maintain the desired spacing 7 between the rotor shrouds 17, 18, 23 and are intended to provide the required strength and rigidity to prevent the shrouds 17, 18, 23 from flexing during operation. The number and position of axial flow vanes 1 is determined by the performance characteristics desired for a particular pump 10. While the rotor 14 is preferably manufactured from a single cast component, it is also acceptable to fabricate the rotor 14 from a weldment or machine from a billet for prototyping and testing.

As shown in FIG. 1, the pump 10 has an outer housing or casing 12, which defines a chamber 13. The chamber 13 has a case inlet 9 and a discharge opening 15. The case inlet 9 is positioned on the chamber 13 to provide an inlet into the centre of the chamber 13. The discharge opening 15 is positioned on the outer edge of the chamber 13 in the illustrated embodiment, although centreline discharge is also possible. The rotor 14 of the pump 10 is positioned in the chamber 13; however, the rotor 14 does not completely fill the chamber 13. There is an annular space 8 within the chamber 13 around the outer edge of the rotor 14. The discharge opening 15 is located adjacent the annular space 8.

A motor (not shown) rotates the rotor shaft 20, which causes the rotor 14 to rotate. The fluid to be pumped is introduced into the pump 10 through case inlet 9. The fluid moves into the spacing 7 that is in fluid communication with the case inlet 9 and apertures 19. The fluid entering the case inlet 9 flows into the area dominated by the axial flow vanes 1 which supercharge fluid in the spacing 7 provided between the disks 17, 18, 23. The rounded face on the rotor hub 22 assists the fluid entering along the axial flow vanes 1 in changing direction from axial flow to radial or mixed flow in the spacing 7 between the rotor shrouds 17, 18, 23. The change in direction is accomplished in a smooth, shock-less manner, thus maintaining the fluid in a laminar flow. By changing the direction of the fluid entering the pump 10, a portion of the inlet velocity of fluid is recovered and utilized by the rotor 14. Recovering a portion of the inlet velocity of the fluid helps to increase the efficiency of the pump 10.

The rotation of the rotor 14 causes the fluid located in the spacing 7 between the rotor shrouds 17, 18, 23 to rotate by transferring momentum to the pumpage. The viscous drag of the fluid allows momentum to be transferred from the walls of the rotating shrouds 17, 18, 23 to the fluid. Viscous drag results from a natural tendency of a fluid to resist flow. Viscous drag occurs whenever a velocity difference exists between a fluid and the constraining passageway or conduit in which the pumpage is located.

As the rotor 14 rotates, the fluid moves in the direction of rotation of the rotor 14 and radially away from the centreline of the rotor 14. The energy transfer begins slowly at the centre of the opening 19 of the rotor 14 adjacent the case inlet 9 and increases as the fluid moves radially further away from the centreline of the rotor 14. The fluid travels in a substantially spiral path from the centreline of the rotor 14; this forces the fluid against the axial flow vanes 1 of the rotor 14 and finally into the annular space 8 in the chamber 13.

The use of the axial flow area defined by the apertures 19 to transfer momentum to the fluid reduces the problems that are normally associated with pumps that use a conventional radial vaned impeller. The pressure on the fluid increases prior to leaving the impeller eye, keeping the pressure higher than the vapour pressure of the fluid, and the static pressure on the fluid acts to suppress cavitation in the fluid.

As the fluid is pumped, it leaves the eye 19 of the rotor 14 and moves into the axial flow vane section, increasing pressure, and continues into the annular space 8 in the chamber 13. The fluid is then under pressure and passes through the discharge opening 15 located in the chamber 13. The pressure and velocity of the discharged fluid depends on the rotation speed and diameter of the rotor 14, the spacing 7 between the disks 17, 18, 23, the number and configuration of vanes 1, and the viscosity of the fluid being pumped. By varying the above factors, the pump 10 can be modified to pump most fluids efficiently at the desired pressure and flow rate. In addition, the rotor 14 can be manufactured in a “mirror image” and is then capable of rotation in the opposite direction.

The pump 10 can also be used to pump abrasive fluids. Abrasive fluids contain solids that can abrade surfaces that the solids contact. A boundary layer of fluid adjacent to the surface of the rotor shrouds 17, 18, 23, however, provides protection for the components of the pump 10. The Reynolds number of the fluid initially determines the thickness of the boundary layer. However, abrupt acceleration and changes in direction of the fluid in the pump 10 can significantly reduce the depth of the boundary layer. If the thickness of the boundary layer is reduced sufficiently, the abrasive solids in the fluid can impinge directly against and abrade the rotor shrouds 17, 18, 23.

In the pump 10, the rotor 14 does not subject the fluid being pumped to any abrupt acceleration or changes in direction. At the inlet opening 19, the fluid moves into the spacing 7 provided between the shrouds 17, 18, 23. When the fluid engages the axial flow vanes 1, the fluid is traveling at substantially the same velocity and in substantially the same direction as the leading portion of the vanes 1. The rotation of the rotor 14 gradually increases the velocity of the fluid, and there are accordingly no abrupt changes in velocity or direction for the fluid to undergo. Thus, the rotor 14 maintains the protective boundary layer and successfully pumps abrasive fluid. In pumping abrasive fluids, the size of the particles in the fluid must be smaller than the spacing 7 between the rotor shrouds 17, 18, 23. The particles must also be able to pass through the case inlet 9 and discharge nozzle 15.

The rotor pump 10 is particularly suitable for materials carrying entrained air or gas, which would be likely to cause “air locking” in centrifugal pumps. The pump 10 is also useful for applications where rapid changes in flow conditions are experienced. Applications in which the rotor pump 10 may advantageously be used include those in which smaller-sized solids pass through the pump, such as pharmaceutical manufacture.

The pump 10 also incorporates an anti-bypass ring 4 that allows for a proper NPSH_{R} test. The anti-bypass ring 4 is preferably cast as part of the rotor 14. In operation, the anti-bypass ring 4 prevents backflow into the suction area at aperture 19 after it has exited the rotor disks 17, 18, 23. During the first overhaul of the pump 10, the anti-bypass ring 4 can be machined away and replaced with a new replaceable ring if significant wear has been experienced.

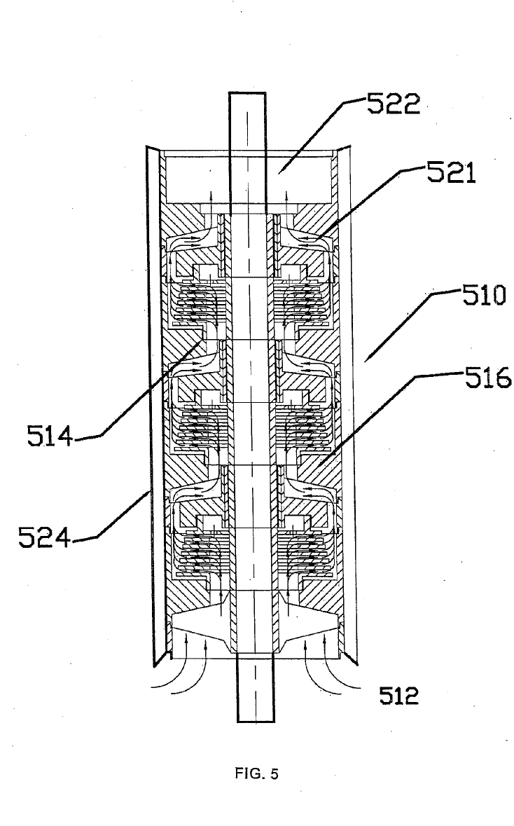

A further embodiment is illustrated in FIGS. 3 and 4, which is referred to as a “high pressure” version of the present invention. Although of slightly different structure, sufficient similarities to the first embodiment exist to retain the same reference numerals, although reference is specifically made to FIGS. 3 and 4. This high pressure version is capable of passing larger solids than the rotor 14 of FIGS. 1 and 2.

The high pressure rotor 14 is capable of fitting in the same position in the pump casing as the rotor of FIG. 1 without modification. Referring now to FIGS. 3 and 4, there is illustrated a single high pressure rotor 14, which is intended to pump heavy oil and other highly viscous and abrasive slurries or sludges having solid contents, as well as fluids having some entrained air or gas. The rotor 14 comprises a pair of shrouds 17, 18 disposed co-axially. The driven rotor shroud 18 has an inlet opening 19 which aligns with the case inlet 9 (shown in FIG. 1) for allowing fluid to flow from the inlet opening 19 into the spacing 7 between the shrouds 17, 18. The driven shroud 18 connects to the drive shroud 17 via the axial flow vanes 1 spaced around the eye 19 of the driven shroud 18. As in the embodiment of FIGS. 1 and 2, the drive shroud 17 connects on its outer face 6 to a suitable drive shaft 20, which connects to a motor for driving the rotor 14. The portion of the rotor hub 22 that protrudes into the inlet opening 19 gently turns the liquid from axial flow to radial flow or a mixed flow pattern.

A plurality of radial ribs 31 are positioned between the two adjacent circular rotor shrouds 17, 18. The radial ribs 31 extend from the outer peripheral edge of the drive and driven disks 17, 18 towards the axial flow vanes 1. The ribs 31 are shown in FIG. 3 as extending approximately 50% of the distance between the outer edge of the disks 17, 18 and the centreline of the rotor 14; however, it should be appreciated that ribs of different length and shape may be utilized on the rotor 14. It is preferable that the raised ribs 31 extend from about 25% to about 75% of the distance between the outer edge of the disks 17, 18 and the centreline of the rotor 14. The raised ribs 31 can also vary in shape and angular position from the raised ribs 31 shown in FIGS. 3 and 4.

Preferably, the shrouds 17, 18, rotor hub 22, axial flow vanes 1, and radial ribs 31 are a cast component of a suitable alloy compatible with the pumpage, although it is also acceptable to fabricate the rotor 14 from a weldment or machine from a billet for prototyping and testing. Accordingly, the cast axial flow vanes 1 are intended to secure these components into a single unit. The cast axial flow vanes 1 are intended to provide the required strength and rigidity to prevent the shrouds 17, 18 from flexing during operation. The number and position of radial ribs 31 is determined by the performance characteristics desired for a particular pump.

In the high pressure embodiment of FIGS. 3 and 4, as the fluid moves from the area 19 to the annular space 8 (shown in FIG. 1), the radial ribs 31 which are positioned between the rotor shrouds 17, 18 engage the fluid. The radial ribs 31 impart additional momentum to the fluid being pumped. The radial ribs 31 and the rotor shrouds 17, 18 define a plurality of partially-open channels in which the fluid flows. The fluid is accelerated in the channels and the fluid moves radially outward into regions of higher rotor velocity. Thus, once the radial ribs 31 engage the fluid, they accelerate the fluid as the fluid moves further away from the centreline of the rotor 14.

There is very little change of direction of the fluid advanced from the inlet opening 19 of the rotor 14 when the axial flow vanes 1 engage the fluid. Consequently, there is a minimum of disruption at the location where the fluid is engaged by the radial ribs 31. Also, the inlet opening 19 increases the static pressure on the fluid as the fluid is advanced towards the spacing 7 encompassing the radial ribs 31, and the pressure on the fluid increases higher than the vapour pressure of the fluid. Therefore, when the pressure on the fluid increases, it acts to suppress cavitation in the fluid. The radial ribs 31 are positioned in the rotor 14 so that the fluid engaged by the radial ribs 31 will be under sufficient static pressure to eliminate cavitation.

The radial ribs 31 of the rotor 14 provide high-efficiency momentum transfer to the pumpage. The radial ribs 31 produce a substantial portion of the momentum transferred to the fluid, while the inlet opening 19 protects the radial ribs 31 from the effect of undesirable fluid inlet conditions. The increase in fluid pressure adjacent the raised ribs 31 due to the axial flow vanes 1 can be from about 5 to about 20 times the increase over pressure at the inlet opening 19.

The pump 10 overcomes the problems of many of the prior art pumps. With the inner, opposing faces of shrouds 17, 18 being optionally convex or concave, the resulting reduced area at the discharge opening 15 can prevent tip cavitation. The inner, opposing faces of the shrouds 17, 18 can also be tapered towards each other, narrowing towards the outer diameter such that the inter-discoid space decreases radially outward. The use of convex or concave disks 17, 18 can also create more space between the outer faces of rotor shrouds 17, 18 and the pump case 12, which reduces the breaking action on high viscosity liquids and lowers the horsepower requirement as compared with pumps with parallel shrouds.

The rotor 14 of FIGS. 3 and 4 also incorporates an anti-bypass ring 4 that allows for a proper NPSH_{R} test. The anti-bypass ring 4 is preferably cast as part of the rotor 14.

Referring now to FIG. 5, there is shown yet another embodiment of a rotor according to the present invention, the rotor designated by the numeral 514. In this third embodiment, a series of rotors 514 are housed within a multi-stage centrifugal pump 510; in embodiments of multi-stage pumps, the drive shaft may extend completely through at least one rotor for powering engagement with additional rotors. The pump 510 comprises an inlet section 512 located to the sides of the pump case 524. The pump 510 also comprises multiple rotors 514 in axial spaced-apart orientation inside the pump case 524. Also inside the pump case 524 are diffuser assemblies 516 that incorporate thrust balancing for the rotors 514. The diffuser assemblies 516 are connected with spigot fits in this embodiment.

The pumped fluid enters the pump 510 at the inlet 512, flows through a diffuser 521, and then moves through each of the rotors 514 until it reaches pump outlet 522, where the fluid is discharged. Increasing the number of rotors 514 increases the pressure of the pump 510; thus, multi-stage pumps are typically used for high pressure applications.

In addition to use in centrifugal pumps, rotors according to the present invention are suitable for mounting on a cantilever shaft of a mixer for mixing, agitation, blending, and keeping solids in suspension. The mixer according to the present invention uses a shear-force technology that is different from existing mixing methods, employing boundary layer/viscous drag forces to move fluid; there are no conventional mixing blades or paddles and no fluid pulsation. Unlike conventional mixers, a mixer according to the present invention, incorporating at least one rotor, delivers mixing, blending, absorption, heat, transfer, and suspension. After the fluid first passes through the rotor, a boundary layer of fluid collects on the rotor disks and rotates at the same velocity. Energy is transferred through viscous drag, generating velocity and pressure; this creates a dynamic force that pulls the fluid through the rotor, in streams of laminar flow, until the entire mass is rotating. Once the liquid/slurry leaves the rotor the situation is one of product pushing adjacent product, rather than an impeller blade pushing or impinging on product. The vast majority of the liquid/slurry accordingly does not touch a moving part of the mechanism. The boundary layer acts as a molecular buffer that prevents impingement of the fluid on the moving parts of the rotor, so the rotor can be used with abrasive product while suffering little or no wear. For this same reason, there is reduced impact on shear-sensitive or delicate products. The mixer's design produces low radial loads and allows longer mixer shaft length, higher rotating speeds and larger diameter impellers. Other benefits of this unique mixing technology include improved longevity and versatility. The particular embodiment herein allows for up to 20:1 rotor to vessel ratios in water-thin liquids, with lower ratios required for more viscous liquids.

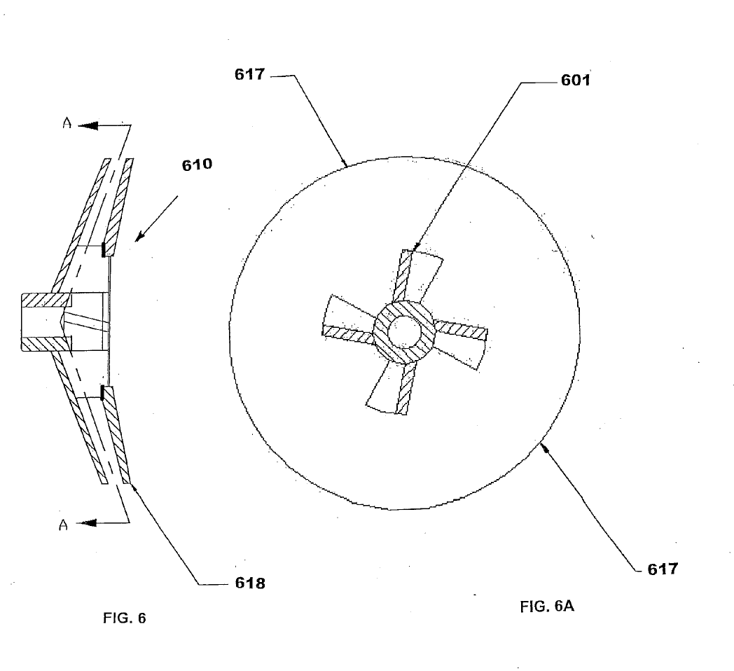

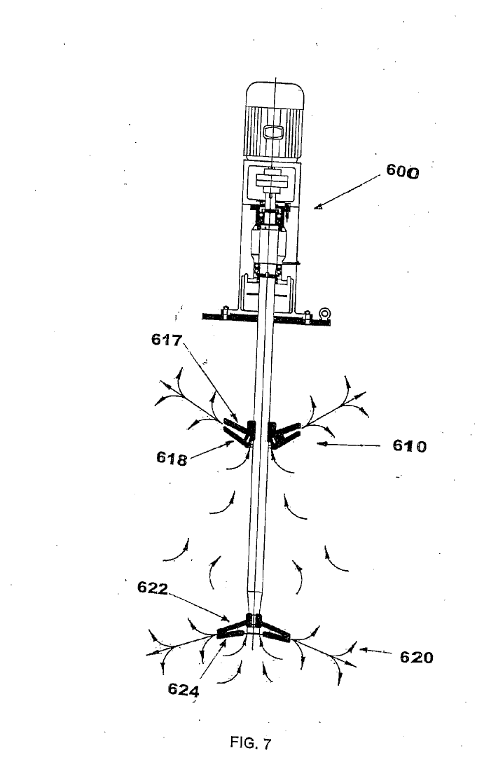

Higher specific gravities and increased viscosities will require higher mixer speeds or larger rotor diameters than that of a water-thin application. Mixers according to the present invention may be provided with two forms of rotors, one basic form with two stacked shrouds (as in FIGS. 6, 6A and 7), and a second with an additional raised internal rib structure (see FIG. 3) for more aggressive mixing and blending. Such raised ribs are useful in applications requiring high shear, emulsification, dissolving air or gas, mixing or blending any product that is not shear sensitive.

In the embodiment of the invention shown in FIGS. 6, 6A, and 7, two rotors 610, 620 are illustrated on a mixer 600, the rotors 610, 620 being vertically adjustable. FIGS. 6 and 6A illustrate a single rotor 610, comprising two shrouds 617, 618, the shrouds 617, 618 connected by vanes 601. In this embodiment, the shrouds 617, 618 are non-parallel, such that the outer edges of the shrouds 617, 618 are closer together than the inner edges. This allows for the ability to direct outlet fluid flow, as is shown in FIG. 7.

With reference to FIG. 7, the ability to direct the flow of liquid within a containment vessel (not shown) by the angle (in relationship to the shaft) of the rotor shrouds 617, 618, 622, 624, allows the direction of the liquids or slurries to be predetermined to enable thorough mixing. A combination of rotors 610, 620, with a variety of flow directional angles, mounted on the same shaft may also be used to scour the corners of the vessel (and thereby bring any solids collecting in such corners into suspension) and also move the liquid/slurry within the containment vessel. However, in some applications, rotors parallel to the drive shaft may be desirable, such as, for example, in mixing two liquids together or dissolving air or gasses. It is also to be understood that, while an embodiment is illustrated comprising two rotors, any desired number of rotors may be employed.

While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment. The invention is therefore to be considered limited solely by the scope of the appended claims.

What is claimed is:

1. A rotor having a rotational axis, the rotor comprising:
at least two discoid members, at least of which being a drive discoid member and at least another of which being a driven discoid member, the at least one drive discoid member and the at least one driven discoid member in spaced relationship along the rotational axis thereby forming inter-discoid spaces;
a drive shaft operably coupled to the drive discoid member;
a centrally positioned aperture in the at least one driven discoid member, the centrally positioned aperture by a peripheral surface and opening into the inter-discoid spaces; and,
at least one axial vane operably connecting the drive discoid member and the peripheral surface of the centrally positioned aperture in the at least one driven discoid member.

2. The rotor of claim 1, further comprising a hub operably connecting the drive discoid member to the drive shaft.

3. The rotor of claim 2, wherein the hub comprises a rounded deflection surface projecting upstream toward the centrally positioned aperture.

4. The rotor of claim 1, wherein the at least one axial vane is disposed at an angle to the rotational axis.

5. The rotor of claim 1, further comprising a anti-bypass ring connected to the most upstream of the at least one driven discoid member.

6. The rotor of claim 1, wherein one discoid member and the discoid member adjacent thereto are non-parallel.

7. The rotor of claim 6, wherein the inter-discoid space between one discoid member and the discoid member adjacent thereto decreases radially outward.

8. The rotor of claim 1, wherein at least one discoid member further comprises at least one raised radial rib.

9. The rotor of claim 1, wherein an end of the rib is disposed proximal to an outer edge of the discoid member.

10. The rotor of claim 1, wherein the rotor comprises at least one discoid pair, said discoid pair having one drive discoid member and the driven discoid member adjacent thereto.

11. The rotor of claim 10, wherein at least one discoid pair is disposed non-perpendicularly to the drive shaft.

12. The rotor of claim 1, wherein at least one discoid member further comprises at least one raised radial rib.

13. The rotor of claim 1, wherein an end of the rib is disposed proximal to an outer edge of the discoid member.

14. A pump comprising a housing, an inlet, at least one outlet, a drive shaft rotatably mounted in the housing, and at least one rotor having a rotational axis and being operably coupled to the drive shaft, the at least one rotor disposed inside and in spaced relation with the housing and having:
at least two discoid members, at least one of which being a drive discoid member and at least another of which being a driven discoid member, the at least one drive discoid member and the at least one driven discoid member in spaced relationship along the rotational axis thereby forming inter-discoid spaces in fluid communication with the at least one outlet;
a centrally positioned aperture in the at least one driven discoid member, the centrally positioned aperture in fluid communication with the inlet and defined by a peripheral surface and opening into the inter-discoid spaces;
at least one axial vane operably connecting the drive discoid member and the peripheral surface of the centrally positioned aperture in the at least one driven discoid member;
in operation the rotation of the rotor causing fluids to be drawn into the housing through the inlet into the centrally positioned aperture in the at least one driven discoid member, then into the inter-discoid spaces and out through the outlet.

15. The pump of claim 14, further comprising a hub operably connecting the drive discoid member to the drive shaft.

16. The pump of claim 15, wherein the hub comprises a rounded deflection surface projecting upstream toward the centrally positioned aperture.

17. The pump of claim 14, wherein the at least one axial vane is disposed at an angle to the rotational axis.

18. The pump of claim 14, further comprising a anti-bypass ring connected to the most upstream of the at least one driven discoid member.

19. The pump of claim 14, wherein one discoid member and the discoid member adjacent thereto are non-parallel.

20. The pump of claim 14, wherein the inter-discoid space between one discoid member and the discoid member adjacent thereto is less than the inter-discoid between said discoid members at the axis of rotation.

21. The pump of claim 14, wherein at least one discoid member further comprises at least one raised radial rib.

22. The pump of claim 14, wherein an end of the rib is disposed proximal to an outer edge of the discoid member.

23. A mixer comprising a body and at least one rotor having a rotational axis, the at least one rotor having:
at least two discoid members, at least one of which being a drive discoid member and at least another of which being a driven discoid member, the at least one drive discoid member and the at least one driven discoid member in spaced relationship along the rotational axis thereby forming inter-discoid spaces;
a centrally positioned aperture in the at least one driven discoid member, the centrally positioned aperture defined by a peripheral surface and opening into the inter-discoid spaces;
a drive shaft rotatably mounted in the body and operably coupled to the drive discoid member; and
at least one axial vane attached to the drive discoid member and the peripheral surface of the centrally positioned aperture in the at least one driven discoid member;
in operation, the rotation of the rotor causing fluids to be drawn into the centrally positioned aperture in the at least one driven discoid member and then into the inter-discoid spaces.

24. The mixer of claim 23, further comprising a hub operably connecting the drive discoid member to the drive shaft.

25. The mixer of claim 24, wherein the hub comprises a rounded deflection surface projecting upstream toward the centrally positioned aperture.

26. The mixer of claim 23, wherein the at least one axial vane is disposed at an angle to the rotational axis.

27. The mixer of claim 23, wherein one discoid member and the discoid member adjacent thereto are non-parallel.

28. The mixer of claim 27, wherein the inter-discoid space between one discoid member and the discoid member adjacent thereto decreases radially outward.

29. The mixer of claim 23, wherein the rotor comprises at least one discoid pair, said discoid pair having one drive discoid member and the driven discoid member adjacent thereto.

30. The mixer of claim 29, wherein at least one discoid pair is disposed non-perpendicularly to the drive shaft.

31. The mixer of claim 23, wherein at least one discoid member further comprises at least one raised radial rib.

32. The mixer of claim 23, wherein an end of the rib is disposed proximal to an outer edge of the discoid member.
